(19) United States
(12) Patent Application Publication
(10) Pub. No.: US 2026/0124633 A1
(43) Pub. Date: May 7, 2026

(54) THICK ELECTRODE COATING APPARATUS FOR SECONDARY BATTERIES

(71) Applicant: BoRuoNieLi (Beijing) Equipment Technology Co., Ltd, Beijing (CN)

(72) Inventor: Junyong WANG, Handan (CN)

(73) Assignee: BoRuoNieLi (Beijing) Equipment Technology Co., Ltd, Beijing (CN)

(21) Appl. No.: 18/977,799

(22) Filed: Dec. 11, 2024

(30) Foreign Application Priority Data
Nov. 7, 2024 (CN) 2024115872482

(51) Int. Cl. B05C 5/02; B05C 11/11; H01M 4/04

(52) U.S. Cl. CPC B05C 5/0208; B05C 5/0225; B05C 11/11; H01M 4/0404

(57) ABSTRACT

Present invention discloses a thick electrode coating apparatus for secondary batteries, specifically relating to lithium battery electrode processing technology. The apparatus comprises a mounting frame, wherein the filtration device and the feed conveying device are fixedly mounted on the mounting frame. A storage device is provided at the rear portion of the mounting frame, and a coating device is slidably mounted on the upper portion of the mounting frame. The thick electrode coating apparatus for secondary batteries of the present invention enables one-time coating of thick electrodes using high-viscosity slurry. Meanwhile, the apparatus can solve a series of problems occurring during high-viscosity slurry coating, such as foil leakage, uneven thickness, and low production efficiency, thereby effectively improving coating capability and quality.

### CROSS-REFERENCE TO RELATED APPLICATIONS

The application claims priority to Chinese patent application No. 2024115872482, filed on Nov. 7, 2024, the entire contents of which are incorporated herein by reference.

### TECHNICAL FIELD

The invention relates to the field of lithium battery electrode processing technology, particularly to a thick electrode coating apparatus for secondary batteries.

### BACKGROUND

In the manufacturing process of secondary batteries, the primary purpose of the front-end process is to produce battery electrodes (taking lithium batteries as an example, the same applies below), mainly including mixing, coating, and rolling processes. The coating process involves applying battery slurry (hereinafter referred to as slurry) onto the surface of the battery current collector (hereinafter referred to as substrate), which forms electrodes after drying.

As is well known, current lithium batteries face challenges of low energy density and high cost, thus improving energy density and reducing cost are objectives pursued by all battery manufacturers. For substrates of the same thickness, applying thicker slurry coatings to achieve higher surface density effectively reduces the proportion of auxiliary materials such as substrates and separators in batteries, thereby significantly improving battery energy density and reducing battery cost. Therefore, producing thick electrodes or high surface density electrodes is a direction all battery manufacturers are striving toward.

The challenge in coating thick electrodes lies in ensuring coating thickness uniformity. Conventional squeeze coating heads or transfer coating heads in the market are adapted to slurry with relatively low viscosity, with production line coating viscosity windows approximately 1500-12000 CP. When coating thick electrodes with low-viscosity slurry, due to good slurry fluidity, thick wet films are affected by pressure balance during internal transportation within the coating head, gravity effects after coating, and uniformity of hot air during baking, making it difficult to maintain a fixed shape on the substrate surface, resulting in poor thickness uniformity that fails to meet usage requirements. Using double-layer coating heads can solve the pressure balance issue during internal transportation, enabling the coating of thicker wet film electrodes, but cannot resolve thickness uniformity issues caused by external forces such as gravity and air uniformity acting on highly fluid slurry. Additionally, the interface resistance between the two wet film layers coated by double-layer coating heads is high, resulting in poor electrode performance.

Therefore, an effective method for one-time thick electrode coating is to increase slurry viscosity.

However, after increasing slurry viscosity, the slurry's fluidity decreases, lacks leveling properties, and its rheological characteristics become more pronounced, making it impossible for current market transfer coating heads and conventional squeeze coating heads to coat high-viscosity slurry.

In conclusion, coating high surface density thick electrodes and coating high-viscosity slurry have become challenging research topics in the new energy industry.

### SUMMARY

The main objective of this invention is to provide a thick electrode coating apparatus for secondary batteries that effectively resolves the problems mentioned in the background technology.

To achieve this objective, the technical solution adopted by this invention is as follows:

A thick electrode coating apparatus for secondary batteries comprises a mounting frame, circulation delivery pump, feed delivery pump, filtration device, feed conveying device, feed pipeline I, and circulation pipeline I. The circulation delivery pump and feed delivery pump are fixed on the upper rear portion of the mounting frame. The filtration device and feed conveying device are fixedly mounted on the upper middle portion of the mounting frame. The filtration device is positioned between the circulation delivery pump and feed conveying device, with these components connected in series by the feed pipeline I.

A storage device is provided at the rear portion of the mounting frame. The output end of the storage device is connected in series with the feed delivery pump through the circulation pipeline I. The output end of the circulation delivery pump is connected to the input end of the storage device, and a coating device is mounted to slide on the upper left portion of the mounting frame.

Preferably, the storage device includes a storage tank with symmetrically installed return and feed pipes at the front and rear of its top. A discharge pipe is installed at the bottom of the storage tank. A motor is installed at the central position of the tank's top wall, with a connecting rod installed through a coupling at the motor's output end. A stirring paddle is installed at the lower end of the connecting rod. The input end of the feed delivery pump connects to the discharge pipe via the circulation pipeline I, while the output end of the circulation delivery pump connects to the return pipe via the feed pipeline I.

Preferably, the coating device comprises multiple guide rails installed on the upper front portion of the mounting frame. Buckles are mounted to slide on the outer surface of each guide rail. Multiple buckles jointly fix the base II at their upper ends. A base I is provided on the upper end of the base II. Multiple support bracket I are fixed at the rear portion of the base I. A connecting plate is jointly fixed at the front end of multiple support bracket I. A coating structure is fixed on the upper end of the base I. Multiple coating head pressure roller drives are provided at the rear end of the base II and mounted on the upper end of the mounting frame.

Preferably, the coating structure comprises a coating valve seat I fixed on the upper end of the horizontal portion of the base I and multiple coating valve seat I installed at the front portion of the base I. A sliding slot I is formed at the front portion of the upper end of the coating valve seat I, and an arc-shaped groove is formed at the rear portion. Multiple coating valve I are mounted to slide within the sliding slot I. A coating valve seat II is fixed at the middle front end of the vertical portion of the base I. A baffle plate is mounted to slide at the middle upper end of the coating valve seat II. Multiple coating valve II are provided at the front end of the coating valve IV. A coating valve III is mounted to slide on the upper end of the coating valve IV and multiple coating valve II. Baffle plates are installed at both the left and right portions of the front end of the coating valve IV, positioned at the left side of the leftmost coating valve II and the right side of the rightmost coating valve II respectively.

Multiple circulation pipeline III are fixed on the upper end of each coating valve II.

Multiple chutes corresponding to the circulation pipeline III on the same side are formed on the upper end of the coating valve III, with the circulation pipeline III positioned within these chutes.

The coating valve II and coating valve III are arranged in multiple sets along the substrate movement direction.

The input ends of the circulation pipeline I are installed at the middle left end and middle right end of the base I and both communicate with the interior of the arc-shaped groove.

Preferably, multiple coating valve III drive, coating valve IV drive, and coating valve seat II are installed at the front end of the connecting plate. The output piston rods of multiple coating valve IV drive penetrate through the vertical portion of the base I and connect to the rear end of the coating valve IV. The output piston rods of multiple coating valve seat II penetrate through the vertical portion of the base I and connect to the coating valve II on their respective sides. Multiple coating valve IV drive are evenly distributed on both sides of multiple coating valve seat II. The output piston rods of multiple coating valve III drive penetrate through the vertical portion of the base I and jointly connect to the rear end of the coating valve III.

Preferably, the lower portion of the outer surface of multiple coating valve II facing the backing roller is formed in an arc shape. An arc groove is formed on the upper portion of the outer surface facing the backing roller. A pressure sensor II is installed at the middle portion of the inner surface of the arc groove. A reflow hole communicating with the interior of the circulation pipeline III on the same side is formed at the front portion of the inner surface of the arc groove.

Preferably, the lower front end of the coating valve seat II is processed with rounded corners and installed with a pressure sensor I.

Preferably, the lower front end of the coating valve III is structured in an arc shape, flat shape, irregular shape, or adjustable configuration.

Preferably, a coating head transverse movement drive device is installed between the base II and the base I.

Compared with existing technology, this invention offers the following beneficial effects:
1. In this invention, the coating valve II are divided into multiple widths in the transverse direction, corresponding to the width distribution of the coating valve I. The slurry flowing from the outlet of the coating valve I produces different coating thicknesses in high-flow and low-flow regions. At this point, by adjusting the gaps between multiple transverse coating valve II and the substrate, the slurry flow is rebalanced in the transverse direction, achieving uniform flow rates across the width, thereby improving coating quality. Simultaneously, the coordination between the coating valve I, II, III, and IV can enhance the diffusion speed of high-viscosity slurry in coating chambers I, II, and III, improving the uniformity of slurry distribution. Additionally, the uniformity of transverse slurry flow can be further controlled by adding coating valves that function similarly to the coating valve II or III.
2. In this invention, pressure sensor I and II are installed in coating chambers II and III to measure slurry pressure. During the coating process, these sensors ensure that the slurry in coating chambers II and III maintains certain pressure levels. Under pressure, the slurry more easily flows into the gaps between coating chambers II and III and the substrate, ensuring perfect adhesion of the slurry to the substrate, further improving coating quality.
3. In this invention, unused slurry can be recycled back to the storage tank through the circulation pipeline III and circulation pipeline I, maximizing slurry utilization, reducing waste, and consequently lowering coating costs.

### BRIEF DESCRIPTION OF DRAWINGS

FIG. 1 is a schematic diagram of the overall structure of the invention;

FIG. 2 is another perspective view of the overall structure of the invention;

FIG. 3 is an enlarged schematic diagram of area A in FIG. 1;

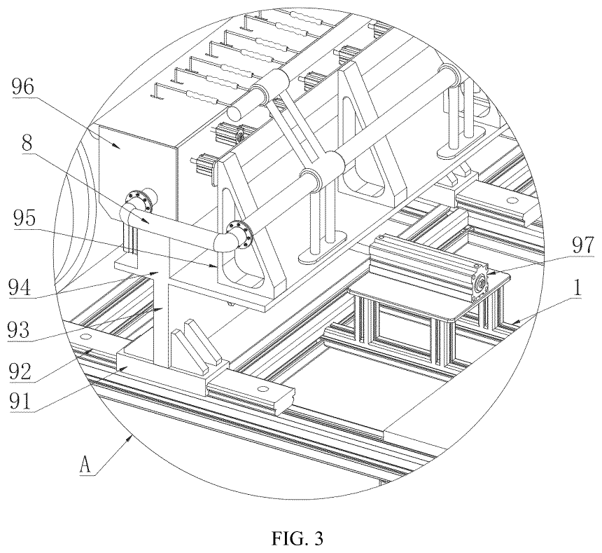

FIG. 4 is a partial structural schematic diagram of the coating structure of the invention;

FIG. 5 is an overall structural schematic diagram of the coating structure of the invention;

FIG. 6 is an enlarged schematic diagram of area B in FIG. 5;

FIG. 7 is a partial front view of the invention;

FIG. 8 is a partial schematic diagram of alternative scheme one for the coating device of the invention;

FIG. 9 is a partial schematic diagram of alternative scheme one for the coating device of the invention.

In the FIGS: 1. mounting frame; 2. storage device; 21. storage tank; 22. stirring paddle; 24. motor; 3. circulation delivery pump; 4. feed delivery pump; 5. filtration device; 6. feed conveying device; 7. feed pipeline I; 8. circulation pipeline I; 9. coating device; 91. buckle; 92. guide rail; 93. base II; 94. base I; 95. support bracket I; 96. coating structure; 961. coating valve I drive; 962. coating valve seat I; 963. sliding slot I; 964. coating valve I; 965. arc-shaped groove; 966. coating valve seat II; 9661. pressure sensor I; 967. coating valve IV; 968. coating valve II; 9681. reflow hole; 9682. pressure sensor II; 9683. arc groove; 969. coating valve III; 971. chute; 972. circulation pipeline III; 973. coating valve III drive; 974. coating valve IV drive; 975. coating valve II drive; 976. baffle plate; 97. coating head pressure roller drive; 981. sliding slot II; 983. screw rod; 984. sliding slot III; 985. coating valve V; 986. coating valve V drive; 987. support bracket II; 10. backing roller; 11. coating substrate.

### DETAILED DESCRIPTION OF THE EMBODIMENTS

To facilitate understanding of the technical means, creative features, purposes, and effects of the present invention, further elaboration is provided below in conjunction with specific embodiments.

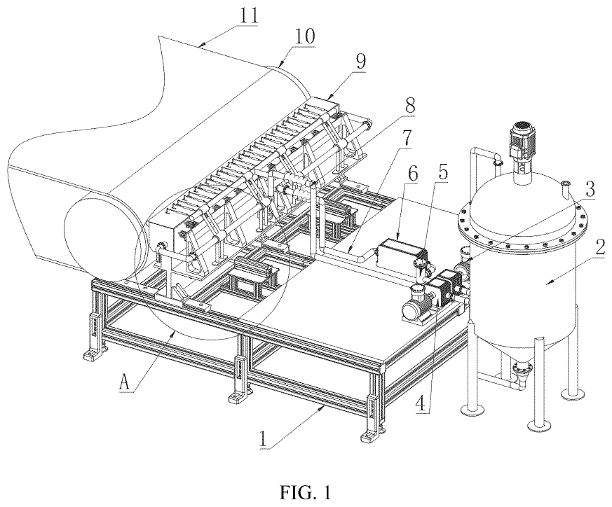

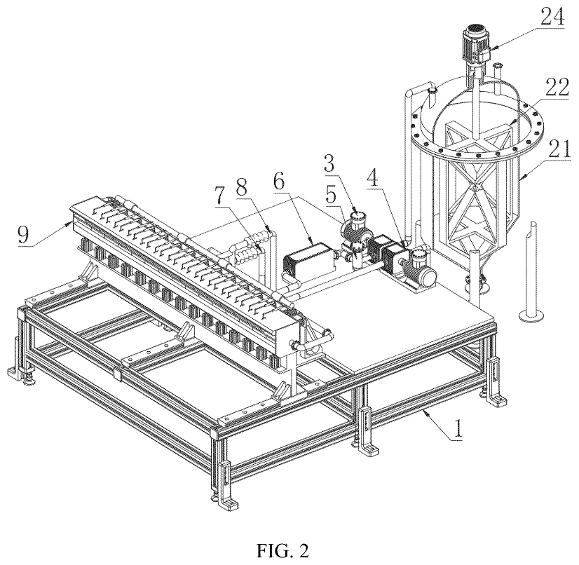

Embodiment 1, as shown in FIGS. 1 and 2, describes a thick electrode coating equipment for secondary batteries, comprising a mounting frame 1, a circulation delivery pump 3, a feed delivery pump 4, a filtration device 5, a feed conveying device 6, a feed pipeline I 7, and a circulation pipeline I 8. The circulation delivery pump 3 and feed delivery pump 4 are fixedly mounted on the rear upper portion of the mounting frame 1. The filtration device 5 and feed conveying device 6 are fixedly mounted on the middle upper portion of the mounting frame 1, with the filtration device 5 positioned between the circulation delivery pump 3 and feed conveying device 6. The circulation delivery pump 3, filtration device 5, and feed conveying device 6 are connected in series by the feed pipeline I 7.

The circulation delivery pump 3, feed delivery pump 4, filtration device 5, and feed conveying device 6 mentioned above are conventional designs in existing technology. In this solution, the filtration device 5 can adopt models such as EJS-N type or EJS-W type from the EAPURE EJS series high-viscosity slurry self-cleaning filters manufactured.

In this solution, the feed conveying device 6 can utilize a screw feeder for material delivery.

The slurry is drawn from the storage device 2 through the circulation delivery pump 3 and passes through the feed pipeline I 7, sequentially flowing through the filtration device 5, feed conveying device 6, coating device 9, circulation pipeline I 8, and feed delivery pump 4, before finally returning to the storage device 2.

Specifically, during implementation, to achieve slurry agitation and reduce bubble content in the slurry, a storage device 2 is installed at the rear of the mounting frame 1. The output end of the storage device 2 is connected in series with the feed delivery pump 4 through the circulation pipeline I 8. The output end of the circulation delivery pump 3 is connected to the input end of the storage device 2, and a coating device 9 is mounted to slide on the left upper portion of the mounting frame 1.

The storage device 2 includes a storage tank 21, with return and feed pipes symmetrically installed at the front and rear of the storage tank 21's top. A discharge pipe is installed at the bottom of the storage tank 21. A motor 24 is installed at the center position of the storage tank 21's top wall. The motor 24's output end is connected to a connecting rod through a coupling, and an agitator blade 22 is installed at the lower end of the connecting rod. The input end of the feed delivery pump 4 is connected to the discharge pipe using the circulation pipeline I 8. The output end of the circulation delivery pump 3 is connected to the return pipe using the feed pipeline I 7. A valve is installed on the outer surface of the circulation pipeline I 8.

Material is fed into the cavity of storage tank 21 through the feed pipe, and through the cooperation of the circulation delivery pump 3, feed pipeline I 7, and discharge pipe, the slurry in the storage tank 21's cavity can be drawn out.

During implementation, after the slurry is injected into the storage tank 21's cavity, the motor 24 is started, and with the cooperation of the connecting rod, it can drive the agitator blade 22 to continuously stir the slurry.

Unused slurry drawn out is pumped back into the storage tank 21's cavity through the feed delivery pump 4 for storage and recycling, reducing material waste. When no coating is being performed, coating valve 964 can be completely closed and the valve on the circulation pipeline I 8 opened to achieve continuous circulation of slurry between the storage tank 21 and the arc-shaped groove 965 of the coating chamber I, preventing slurry sedimentation.

The filtration device 5 can filter out impurities or particles in the slurry. The feed conveying device 6 delivers the filtered slurry to the coating chamber I through pipelines.

Embodiment 2, building upon Embodiment 1, describes how the pumped material is coated onto the coating substrate 11 through the coating device 9.

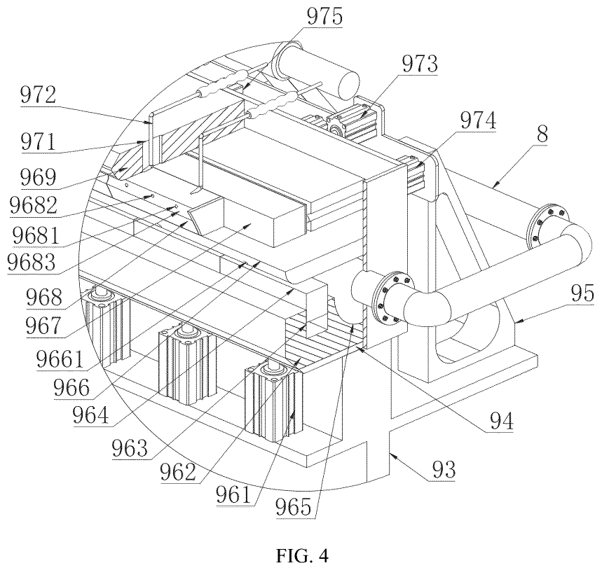

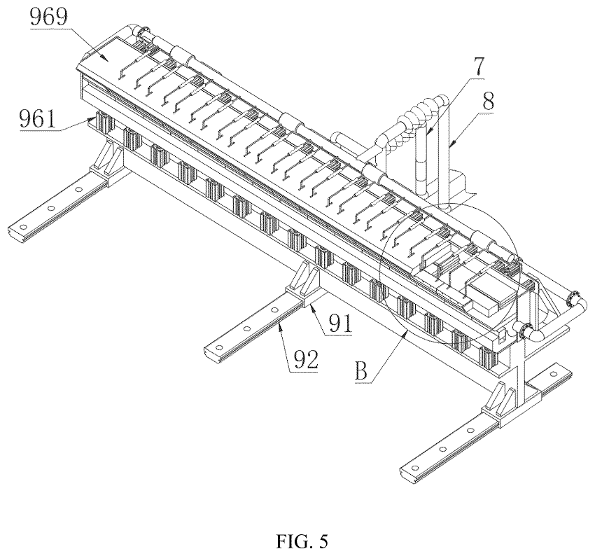

Specifically, to achieve the aforementioned purpose, referring to FIGS. 4-7, the coating device 9 comprises multiple sliding rails 92 installed on the front upper portion of the mounting frame 1. Multiple sliding buckles 91 mounted to slide on the outer surface of the sliding rails 92. A base II 93 is jointly fixed to the upper ends of the multiple sliding buckles 91. A base I 94 is mounted on top of the base II 93. Multiple support frames 95 are fixed to the rear portion of the base I 94. A connecting plate is jointly fixed to the front ends of the multiple support frames 95. A coating structure 96 is fixed to the upper end of the base I 94. Multiple coating head pressure roller drives 97 are installed on the mounting frame 1 at the rear end of the base II 93.

Through the cooperation of the sliding buckles 91 and sliding rails 92, the base II 93, base I 94, and multiple support frames 95 can slide on the front upper portion of the mounting frame 1 under the drive of the coating head pressure roller drives 97.

To facilitate the movement of the coating structure 96 while enabling feed and return, the middle portions of the feed pipeline I 7 and circulation pipeline I 8 are high-pressure flexible hoses. This ensures that while the front portions of the feed pipeline I 7 and circulation pipeline I 8 can move, their rear portions maintain stability, guaranteeing normal slurry transmission.

The support frames 95 mentioned above support the power sources inside the coating structure 96, such as the coating valve III drive 973, coating valve IV drive 974, and coating valve II drive 975, enabling them to drive the structure's operation.

The coating structure 96 includes a coating valve seat I 962 fixed on the horizontal portion of the base I 94 and multiple coating valve I drive 961 installed on the front of the base I 94. A sliding slot I 963 is formed on the front upper portion of the coating valve seat I 962, and an arc-shaped groove 965 is formed on the rear upper portion. Multiple coating valve I 964 slide within the sliding slot I 963. A coating valve seat II 966 is fixed to the middle front end of the vertical portion of the base I 94. A baffle plate 976 slides in the middle upper portion of the coating valve seat II 966. Multiple coating valve II 968 are installed at the front end of the coating valve IV 967. A coating valve III 969 slides jointly on top of the coating valve IV 967 and the multiple coating valve II 968. Baffle plates 976 are installed on the left and right front portions of the coating valve IV 967, positioned to the left of the leftmost coating valve II 968 and to the right of the rightmost coating valve II 968.

The multiple coating valve I 964 divide the space between the coating valve seat II 966 and coating valve seat I 962 into front and rear portions, defined as the coating chamber II and coating chamber I respectively.

An arc groove 9683 is formed on the upper portion of the coating valve II 968's outer surface facing the backing roller 10.

The cavity between the arc groove 9683 and the coating substrate 11's outer surface is defined as the coating chamber III.

The width of the coating chamber I in the horizontal direction is similar to the coating width. The slurry spreads horizontally in the coating chamber I before entering the coating chamber II through the coating valve I 964. The width of the coating valve I 964 matches that of the coating chamber I, with multiple blocks continuously arranged horizontally. Adjusting the gap between the coating valve I 964 and the coating valve seat II 966 provides initial control over the uniformity of slurry flow from the coating chamber I to the coating chamber II in the horizontal direction.

However, viewing from the horizontal direction, variations in slurry flow from the coating chamber I to the coating chamber II are inevitable. When not coating, the coating valve I 964 can be fully closed and the valve on the circulation pipeline I 8 opened to achieve continuous circulation of slurry between the storage tank 21 and the coating chamber I, preventing slurry sedimentation.

Multiple circulation pipelines III 972 are fixed to the upper ends of the multiple coating valve II 968.

The multiple circulation pipeline III 972 are all connected to the circulation pipeline I 8, simultaneously returning unused slurry.

Multiple chutes 971 corresponding to the circulation pipeline III 972 on the same side are formed on top of the coating valve III 969, with the multiple circulation pipeline III 972 positioned within their respective chutes 971.

During implementation, the horizontal position of the coating valve III 969 changes, and relative sliding occurs between the coating valve II 968 and the coating valve III 969. To enable normal discharge of excess slurry through the reflow holes 9681 via the circulation pipeline III 972, the circulation pipeline III 972 must move synchronously with the coating valve II 968. The chutes 971 are designed to prevent the coating valve III 969 from compressing the circulation pipeline III 972 during movement, ensuring the integrity of the circulation pipeline III 972.

Similarly, the middle portions of the multiple circulation pipeline III 972 are also high-strength flexible hoses, designed to extend the movement path of the circulation pipeline III 972.

The coating valve II 968 and coating valve III 969 are arranged in multiple units along the substrate movement direction.

The input ends of the circulation pipeline I 8 are installed at the middle left and right ends of the base I 94 and communicate with the interior of the arc-shaped groove 965, allowing excess slurry in the coating chamber I or slurry when the coating valve I 964 are closed to return to the storage tank 21's cavity through the circulation pipeline I 8.

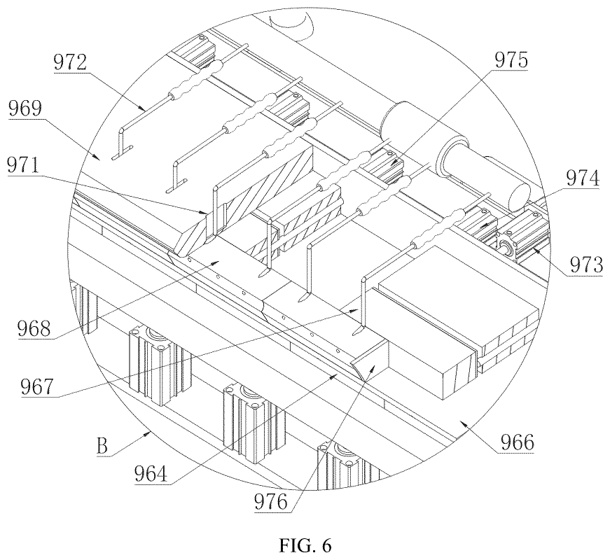

Furthermore, referring to FIGS. 4 and 6, multiple coating valve III drive 973, coating valve IV drive 974, and coating valve II drive 975 are installed at the front end of the connecting plate. The piston rods at the output ends of the multiple coating valve IV drive 974 penetrate through the vertical portion of the base I 94 and connect to the rear end of the coating valve IV 967. The piston rods at the output ends of the multiple coating valve II drive 975 penetrate through the vertical portion of the base I 94 and connect to their respective coating valve II 968 on the same side. The multiple coating valve IV drive 974 are evenly distributed on both sides of the multiple coating valve II drive 975. The piston rods at the output ends of the multiple coating valve III drive 973 penetrate through the vertical portion of the base I 94 and jointly connect to the rear end of the coating valve III 969.

The multiple coating valve III drive 973, coating valve IV drive 974, and coating valve II drive 975 mentioned above can respectively control the left-right movement of the coating valve III 969, coating valve IV 967, and coating valve II 968.

However, when the multiple coating valve IV drive 974 begin operating, the multiple coating valve III drive 973 need to move synchronously. After the coating valve IV 967 moves forward to the designated position, the multiple coating valve II 968 can continue moving forward independently.

The lower portion of the coating valve II 968's outer surface facing the backing roller 10 is arc-shaped, further conforming to the shape formed by the coating substrate 11 bending around the backing roller 10's surface, improving the coating effect of the slurry. A pressure sensor II 9682 is installed in the middle of the arc groove 9683's inner surface. Reflow holes 9681 communicating with the corresponding circulation pipeline III 972's cavity are formed in the front portion of the arc groove 9683's inner surface.

The front lower portion of the coating valve seat II 966 is rounded and equipped with a pressure sensor I 9661.

The front lower portion of the coating valve III 969 features an arc-shaped, flat, irregular, or adjustable structure, further conforming to the shape formed by the coating substrate 11 bending around the backing roller 10's surface, improving the coating effect of the slurry.

During implementation, the substrate wraps around the backing roller 10 and moves with its rotation, stabilizing the coating state. When the slurry fills the coating chamber II, it is already coated onto the substrate.

To achieve perfect adhesion of the slurry to the substrate and resolve foil missing issues during coating, referring to FIG. 4, multiple pressure sensor I 9661 are installed on the rounded front lower portion of the coating valve seat II 966.

The pressure sensor I 9661 feed back the slurry pressure in the coating chamber II to the electrical control system. The system performs PID adjustment based on the actual pressure and set pressure, controlling the slurry flow rate from the feed conveying device 6 to the coating chamber I, maintaining the pressure in the coating chamber II within the system's set pressure range.

As the backing roller 10 carries the coating substrate 11, and the coating substrate 11 carries the adhered slurry toward the coating chamber III, this effectively adds continuous slurry delivery power within the die head, resolving the issue of excessive delivery pressure for high-viscosity slurry.

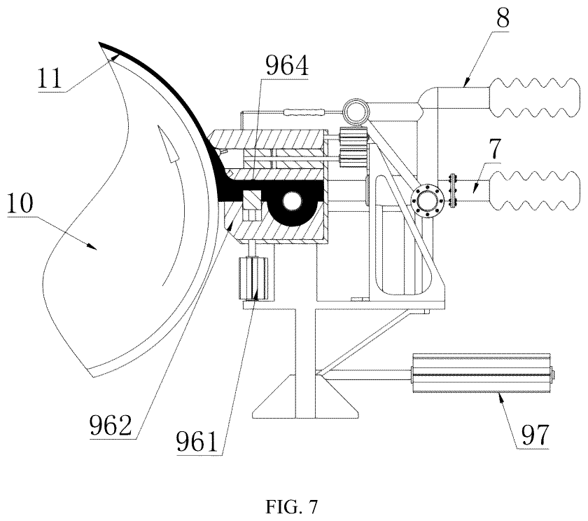

The coating substrate 11 carries the slurry from the coating chamber II to the coating chamber III, passing through the coating valve II 968. As shown in FIG. 7, multiple coating valve IV 967 are arranged in parallel close formation, combining to achieve the target coating width.

The coating valve II 968 can use the coating valve IV 967 as support and move toward the backing roller 10 under the drive of the coating valve I 964 and arc-shaped groove 965, adjusting the gap between the coating valve II 968 and the substrate.

During coating, the slurry passes through the gap between the coating valve II 968 and the substrate. At the same coating speed, controlling different gaps in the horizontal direction serves to control the uniform distribution of flow rates horizontally.

When the slurry passes through the coating valve I 964, its horizontal flow velocities differ. According to the slurry's rheological properties, the horizontal flow rate distribution varies. When the slurry passes through the gap between the coating valve II 968 and the substrate, appropriate gap adjustment ensures that after passing through the coating valve II 968 and reaching the coating chamber III, the slurry flow rates tend toward uniformity.

The solution also includes four baffle plates 976, installed on both sides of the coating chamber II and III. The baffle plates 976 control the slurry width on the coating substrate 11, constraining the slurry within the target coating width region when viewed horizontally.

When high-viscosity slurry of the same viscosity reaches the coating chamber III, it can balance the horizontal pressure within the coating chamber III.

Valves are also installed between the circulation pipeline III 972 and the circulation pipeline I 8.

With the valves on the circulation pipeline III 972 closed, controlling the operation of the coating valve IV drive 974 and coating valve II drive 975 drives the movement of the coating valve IV 967 and coating valve II 968, appropriately adjusting the gap between the coating valve II 968 and the coating substrate 11, thereby achieving good slurry flow uniformity.

Under the control system's closed-loop control, the pressure in the coating chamber III can be maintained within the set range. When excessive local pressure is detected horizontally in the coating chamber III, and gap adjustment affects slurry uniformity, the opening of valves on the corresponding circulation pipeline III 972 needs adjustment to balance the slurry pressure in the coating chamber III.

After flow uniformization treatment and pressure stabilization, the high-viscosity slurry passes through the gap between the coating valve III 969 and the coating substrate 11, forming stable electrode plates that achieve the target thickness.

Due to the low flowability characteristics of high-viscosity slurry, this coating device can achieve stable coating of thick electrode plates.

In this solution, the coating valve IV drive 974, coating valve II drive 975, coating head pressure roller drives 97, coating valve III drive 973, and coating valve I drive 961 can employ electric cylinders, pneumatic cylinders, or hydraulic cylinders in the implementation, provided the generated thrust meets production requirements.

A coating head lateral movement drive device is installed between the base II 93 and base I 94.

The lateral drive device mentioned above is a conventional design in existing technology, comprising a concave fixed baseplate, threaded rod, and servo motor. The base I 94 is connected to the threaded rod via threads and slidably connected to the concave fixed baseplate. The concave fixed baseplate is mounted on top of the base II 93, the threaded rod is rotatably connected to the fixed baseplate, and the servo motor is installed on the side of the concave fixed baseplate to drive the threaded rod's rotation, thereby enabling lateral movement of the coating structure 96 and other components.

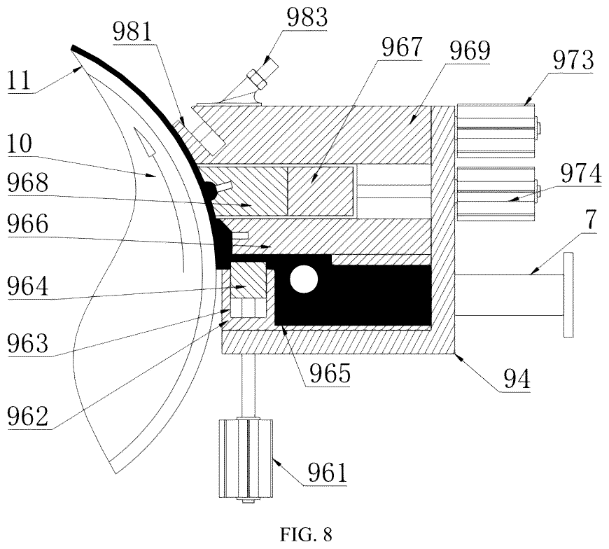

Embodiment 3 presents an alternative solution for the coating device 9, as shown in FIG. 8. This solution modifies the shape of the arc-shaped groove 965 and adds a sliding slot II 981 and screw rods 983 based on Embodiments 1 and 2. All other structural installation methods and positions remain the same as in Embodiments 1 and 2.

Similarly, a sliding slot II 981 that communicates left and right is formed in the upper front portion of the coating valve III 969. Multiple screw rods 983 are rotatably connected at equal intervals on the side of the sliding slot II 981's cavity facing the backing roller 10. The multiple screw rods 983 all penetrate through the side of the sliding slot II 981's cavity away from the backing roller 10, extending outward and rotatably connecting to the side of the coating valve III 969 away from the backing roller 10.

During implementation, by rotating the screw rods 983 clockwise or counterclockwise, the angle of the coating valve III 969's side facing the coating substrate 11 can be adjusted, thereby correcting the linearity of the slurry on the coating substrate 11 to improve coating quality.

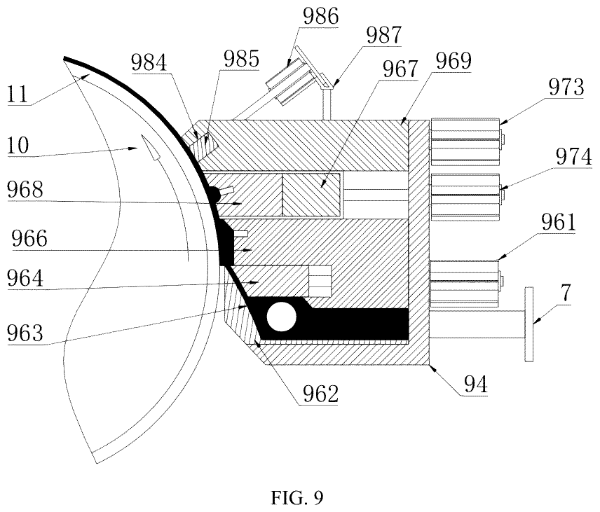

Embodiment 4 presents a second alternative solution for the coating device 9, as shown in FIG. 9. This embodiment changes the installation positions of the coating valve I drive 961 and coating valve I 964, converting their orientation from vertical to horizontal. The coating valve I drive 961 and coating valve I 964 are positioned on the same horizontal plane and below the coating valve IV drive 974. Based on Embodiments 1 and 2, this embodiment adds a sliding slot III 984, coating valve V 985, coating valve V drive 986, and support frame II 987. All other structural installation methods and positions remain the same as in Embodiments 1 and 2.

As shown in FIG. 9, the side of the coating valve I 964 facing the coating substrate 11 is arc-shaped to improve slurry flow smoothness.

The multiple coating valve I drive 961 can all be installed on the support frame I 95.

Specifically, a sliding slot III 984 is formed at the front end of the coating valve III 969. Multiple horizontally distributed coating valve V 985 slide within the sliding slot III 984's cavity. coating valve V drive 986 are installed in the middle of each coating valve V 985's side away from the coating substrate 11. support frame II 987 are jointly fixed between the rear ends of the multiple coating valve V drive 986 and the coating valve III 969.

In this solution, the coating valve V drive 986 can utilize electric cylinders, pneumatic cylinders, or hydraulic cylinders during implementation, provided the generated thrust meets production requirements.

This embodiment adds multiple coating valve V 985 whose extension lengths can be individually adjusted under the drive of the coating valve V drive 986, enabling correction of slurry linearity on the coating substrate 11 to improve coating quality.

Those skilled in the art should understand that the present invention is not limited to the above embodiments. The embodiments and descriptions in the specification only illustrate the principles of the present invention. Under the premise of not departing from the spirit and scope of the present invention, the present invention may have various changes and improvements, all of which fall within the scope of protection claimed by the present invention. The scope of protection of the present invention is defined by the appended claims and their equivalents.

What is claimed is:

1. A thick electrode coating apparatus for secondary batteries, comprising a mounting frame (1), a circulation delivery pump (3), a feed delivery pump (4), a filtration device (5), a feed conveying device (6), a feed pipeline I (7), and a circulation pipeline I (8), characterized in that:
the circulation delivery pump (3) and the feed delivery pump (4) are fixedly installed on the upper rear portion of the mounting frame (1), the filtration device (5) and the feed conveying device (6) are fixedly mounted on the upper middle portion of the mounting frame (1), the filtration device (5) is positioned between the circulation delivery pump (3) and the feed conveying device (6), the circulation delivery pump (3), filtration device (5), and feed conveying device (6) are connected in series by the feed pipeline I (7);
The storage device (2) is provided at the rear portion of the mounting frame (1), the output end of the storage device (2) is connected in series with the feed delivery pump (4) through the circulation pipeline I (8), the output end of the circulation delivery pump (3) is connected to the input end of the storage device (2), and a coating device (9) is mounted to slide on the upper left portion of the mounting frame (1).

2. The thick electrode coating apparatus for secondary batteries according to claim 1, characterized in that:
the storage device (2) comprises a storage tank (21), the top of the storage tank (21) is symmetrically installed with a return pipe and a feed pipe at front and rear positions respectively, the bottom of the storage tank (21) is installed with a discharge pipe, a motor (24) is installed at the central position of the top wall of the storage tank (21), a connecting rod is installed at the output end of the motor (24) through a coupling, a stirring paddle (22) is installed at the lower end of the connecting rod, the input end of the feed delivery pump (4) is connected to the discharge pipe through the circulation pipeline I (8), and the output end of the circulation delivery pump (3) is connected to the return pipe through the feed pipeline I (7).

3. The thick electrode coating apparatus for secondary batteries according to claim 1, characterized in that:
the coating device (9) comprises multiple guide rails (92) installed on the upper front portion of the mounting frame (1), buckles (91) are mounted to slide on the outer surface of each guide rail (92), the base II (93) is jointly fixed on the upper end of multiple buckles (91), the base I (94) is provided on the upper end of the base II (93), multiple support bracket I (95) are fixed at the rear portion of the base I (94), a connecting plate is jointly fixed at the front end of multiple support bracket I (95), a coating structure (96) is fixed on the upper end of the base I

(94) and multiple coating head pressure roller drives (97) are provided at the rear end of the base II (93) and mounted on the upper end of the mounting frame (1).

4. The thick electrode coating apparatus for secondary batteries according to claim 3, characterized in that:
the coating structure (96) comprises a coating valve seat I (962) fixed on the upper end of the horizontal portion of the base I (94) and multiple coating valve I drive (961) installed at the front portion of the base I (94), a sliding slot I (963) is formed at the front portion of the upper end of the coating valve seat I (962), an arc-shaped groove (965) is formed at the rear portion of the upper end of the coating valve seat I (962), multiple coating valve I (964) are mounted to slide within the sliding slot I (963), a coating valve seat II (966) is fixed at the middle front end of the vertical portion of the base I (94), a baffle plate (976) is mounted to slide at the middle upper end of the coating valve seat II (966), multiple coating valve II (968) are provided at the front end of the coating valve IV (967), a coating valve III (969) is mounted to slide on the upper end of the coating valve IV (967) and multiple coating valve II (968), baffle plates (976) are installed at both the left and right portions of the front end of the coating valve IV (967), and the two baffle plates (976) are positioned at the left side of the leftmost coating valve II (968) and the right side of the rightmost coating valve II (968) respectively;
multiple circulation pipeline III (972) are fixed on the upper end of each coating valve II (968);
multiple chutes (971) corresponding to the circulation pipeline III (972) on the same side are formed on the upper end of the coating valve III (969), and multiple circulation pipeline III (972) are positioned within multiple chutes (971) respectively;
the coating valve II (968) and the coating valve III (969) are arranged in multiple sets along the substrate movement direction;
the input ends of the circulation pipeline I (8) are installed at the middle left end and middle right end of the base I (94) and both communicate with the interior of the arc-shaped groove (965).

5. The thick electrode coating apparatus for secondary batteries according to claim 4, characterized in that:
multiple coating valve III drive (973), multiple coating valve IV drive (974), and multiple coating valve II drive (975) are installed at the front end of the connecting plate, the output piston rods of multiple coating valve IV drive (974) penetrate through the vertical portion of the base I (94) and are connected to the rear end of the coating valve IV (967) respectively, the output piston rods of multiple coating valve II drive (975) penetrate through the vertical portion of the base I (94) and are connected to the coating valve II (968) on the same side respectively, multiple coating valve IV drive (974) are evenly distributed on both left and right sides of multiple coating valve II drive (975), and the output piston rods of multiple coating valve III drive (973) penetrate through the vertical portion of the base I (94) and are jointly connected to the rear end of the coating valve III (969).

6. The thick electrode coating apparatus for secondary batteries according to claim 5, characterized in that:
the lower portion of the outer surface of multiple coating valve II (968) facing the backing roller (10) is formed in an arc shape, an arc groove (9683) is formed on the upper portion of the outer surface of the coating valve II (968) facing the backing roller (10), a pressure sensor II (9682) is installed at the middle portion of the inner surface of the arc groove (9683), and a reflow hole (9681) communicating with the interior of the circulation pipeline III (972) on the same side is formed at the front portion of the inner surface of the arc groove (9683).

7. The thick electrode coating apparatus for secondary batteries according to claim 4, characterized in that:
the lower front end of the coating valve seat II (966) is processed with rounded corners and installed with a pressure sensor I (9661).

8. The thick electrode coating apparatus for secondary batteries according to claim 4, characterized in that:
the lower front end of the coating valve III (969) is structured in an arc shape, flat shape, irregular shape, or adjustable configuration.

9. The thick electrode coating apparatus for secondary batteries according to claim 3, characterized in that:
a coating head transverse movement drive device is installed between the base II (93) and the base I (94).
